(19) United States
(12) Patent Application Publication
(10) Pub. No.: US 2006/0127020 A1
(43) Pub. Date: Jun. 15, 2006

(54) Apparatus for fabricating optical fiber cable

(75) Inventors: Hoon-Soo Park, Gwangmyeong-si (KR); Jin-Han Kim, Gumi-si (KR)

Correspondence Address: CHA & REITER, LLC, 210 ROUTE 4 EAST STE 103, PARAMUS, NJ, 07652, US

(73) Assignee: Samsung Electronics Co.; LTD

(21) Appl. No.: 11/229,815

(22) Filed: Sep. 19, 2005

(30) Foreign Application Priority Data
Dec. 10, 2004 (KR) 2004-104121

(51) Int. Cl. G02B 6/036

(52) U.S. Cl. 385/128; 385/100

(57) ABSTRACT

An apparatus for fabricating a metal coated optical fiber cable is disclosed. The apparatus includes a tape forming unit causing both side edges of a metal strip subjected to traction to abut against each other to form a metal tape, an optical fiber guide unit for guiding an optical fiber or an optical fiber bundle into the metal tape, a welding unit for welding abutment portions of the metal tape against each other, and a fastening unit surrounding the metal tape having the welded abutment portions in order to maintain a shape of the metal tape. The fastening unit is formed at an inner peripheral portion thereof, which makes contact with the metal tape, with a concave-convex section.

### CLAIM OF PRIORITY

This application claims the benefit of the earlier patent application entitled “Apparatus For Fabricating Optical Fiber Cable,” filed with the Korean Intellectual Property Office on Dec. 10, 2004 and assigned Serial No. 2004-104121, the entire contents of which are incorporated herein by reference.

### BACKGROUND OF THE INVENTION

1. Field of the Invention

The present invention relates to an apparatus for fabricating an optical fiber cable. More particularly, the present invention relates to an apparatus for fabricating an optical fiber cable, which includes a device for forming a metal tape.

2. Description of the Related Art

Generally, an optical fiber cable includes an outer jacket accommodating a plurality of optical fibers, a plurality of loose tubes having the optical fibers, or a plurality of ribbon optical fibers to protect the optical fibers from external environment, a filler member for dampening any shock applied to the optical fiber cable, and a waterproof member for preventing water from penetrating into the optical fiber cable. In addition, the optical fiber cable may further include a plurality of tension members for reinforcing tensile force thereof and a metal tape.

The metal tape not only protects the optical fiber cable from external impact, but also prevents water from penetrating into the optical fiber cable. In general, the metal tape is aligned at an inner portion of the outer jacket lengthwise along the outer jacket by means of a separate device in such a manner that the metal tape can surround the optical fibers.

An apparatus for accommodating the metal tape in the optical fiber cable is disclosed in detail in U.S. Pat. No. 5,440,095, which is entitled “Apparatus for Manufacturing Metal Tube Covered Optical Fiber Cable and Method Therefor,” issued to Yoshie, et al. Aug. 8, 1995.

The Yoshie apparatus includes a fastening unit for maintaining a shape of a metal tape when the metal tape is formed. The fastening unit has a circular tube shape identical to the shape of the metal tape.

However, in the Yoshie apparatus, excessive tension is applied to the optical fiber cable while the optical fiber cable is being withdrawn from the fastening unit having the circular tube shape. In this case, the optical fiber cable may be broken while being withdrawn from the fastening unit when an excessive tension applied thereto.

### SUMMARY OF THE INVENTION

Accordingly, the present invention has been made to solve the above-mentioned problems occurring in the prior art and provides additional advantages, by providing an apparatus for fabricating an optical fiber cable, which includes a fastening unit capable of maintaining a shape of a metal tape by reducing tension applied to the optical fiber cable.

In one embodiment, there is provided an apparatus for fabricating a metal coated optical fiber cable, the apparatus comprising a tape forming unit causing both side edges of a metal strip subjected to traction to abut against each other to form a metal tape, an optical fiber guide unit for guiding an optical fiber or an optical fiber bundle into the metal tape, a welding unit for welding abutment portions of the metal tape against each other, and a fastening unit surrounding the metal tape having the welded abutment portions in order to maintain a shape of the metal tape, wherein the fastening unit is formed at an inner peripheral portion thereof, which makes contact with the metal tape, with a concave-convex section.

### BRIEF DESCRIPTION OF THE DRAWINGS

The above features and advantages of the present invention will be more apparent from the following detailed description taken in conjunction with the accompanying drawings, in which:

FIG. 1 is a view illustrating a structure of an apparatus for fabricating an optical fiber cable according to an embodiment of the present invention; and

FIGS. 2 to 4 are sectional views illustrating various inner peripheral structures of a fastening unit shown in FIG. 1 according to embodiments of the present invention.

### DETAILED DESCRIPTION

Hereinafter, preferred embodiments of the present invention will be described with reference to the accompanying drawings. For the purposes of clarity and simplicity, a detailed description of known functions and configurations incorporated herein will be omitted when it may make the subject matter of the present invention unclear.

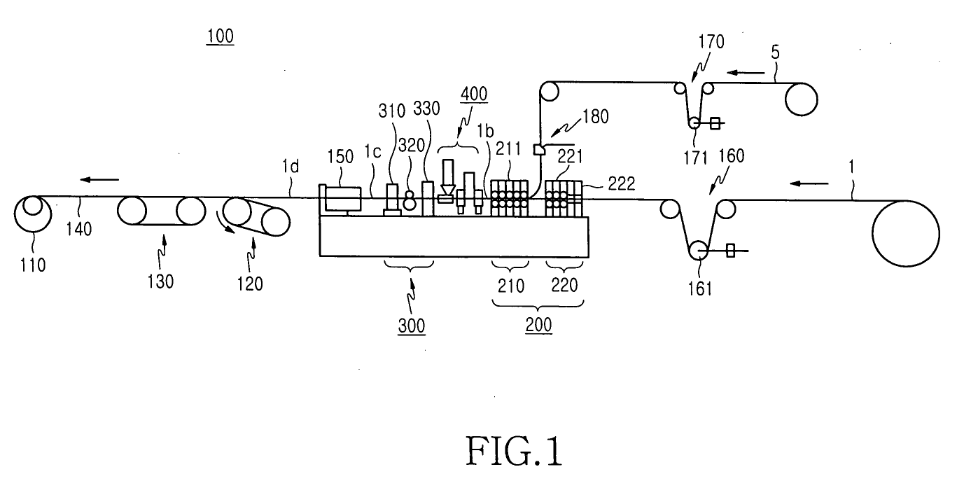

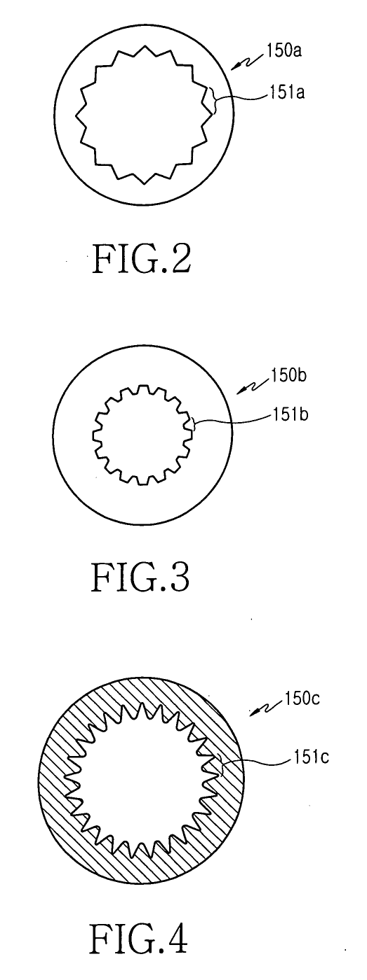

FIG. 1 is a view illustrating a structure of an apparatus 100 for fabricating an optical fiber cable according to an embodiment of the present invention, and FIG. 2 is a sectional view of a fastening unit according to one embodiment of the present invention. The apparatus 100 is used for fabricating the optical fiber cable including a plurality of optical fibers or loose tubes and a ribbon optical fiber bundle. In particular, the apparatus 100 may be used for fabricating the optical fiber cable including a metal tape.

The apparatus 100 includes a tape forming unit 200 causing both side edges of a metal strip 1, subjected to traction, to abut against each other to form a metal tape 1b, an optical fiber guide unit 180 for guiding an optical fiber 5, or an optical fiber bundle, into the metal tape 1b, a welding unit 400 for sealing the abutment portions of the metal tape 1b, and a plurality of traction units 110, 120 and 130 for continuously pulling the metal tape 1b.

The tape forming unit 200 includes first and second taping assemblies 210 and 220 in order to cause both side edges of the metal strip 1 to abut against each other to form the metal tape 1b.

The optical fiber guide unit 180 is aligned between the first and second taping assemblies 220 and 210, respectively, so as to guide the optical fiber 5 into the metal tape 1b. The optical fiber guide unit 180 may include a guide tube, a tube connector and a gas feeding tube for feeding inert gas. In addition, the optical fiber guide unit 180 may guide a loose tube or a ribbon optical fiber bundle into the metal tape 1b, instead of the optical fiber 5, according to the structure of the optical fiber cable.

The welding unit 400 is used for bonding the abutment portions of the metal tape 1b receiving the optical fiber 5. The welding unit 400 radiates coherent light onto the abutment portions of the metal tape 1b, thereby bonding the abutment portions of the metal tape 1b against each other. A support roll stand 310, a speed meter 320 and an eddy current tester 330 are positioned at a rear portion of the welding unit 400 in order to monitor the welding state of the metal tape 1c.

In addition, the apparatus 100 includes a fastening unit 150 for maintaining a shape of the welded metal tape 1c while reducing an outer diameter of the welded metal tape 1c. The fastening unit 150 has an inner diameter identical to an outer diameter of the metal tape 1c and includes a rolling die made from a metal, plastic or graphite. It is also possible to divide the fastening unit 150 into at least two parts. Referring to FIGS. 2 to 4, which are sectional views of the fastening unit, fastening units 150a-150c are formed at inner peripheral portions thereof with concave-convex sections 151a-151c, which extend lengthwise along the fastening units 150a-150c, respectively, in a linear pattern or a helical pattern.

The concave-convex sections 151a-151c may have various shapes, such as circular, angular 150a, trapezoidal 150b, or triangular 150c, shapes. The number of concave parts and convex parts of the concave-convex sections 151a-151c may vary depending on the outer diameter of the welded metal tape 1c. In detail, if the inner diameter of the fastening unit 150 is in a range of about 1 to 100 mm, a height or a depth of the concave-convex sections 151a-151c may be in a range of about 0.1 to 5 mm. In a preferred embodiment, the number of concave parts or convex parts aligned in a circumferential direction of the fastening unit is in a range of about 5 to 20 per centimeter(cm).

According to the present invention, a contact area between the fastening unit and the welded metal tape 1c is minimized, so friction between the fastening unit and the welded metal tape 1c is significantly reduced, thereby preventing excessive tension from being applied to the metal tape 1c.

Returning to FIG. 1, the traction units 110 to 130 wind the metal tape 1d around a capstan while adjusting tension applied to the metal tape 1d.

As described above, the apparatus for fabricating the optical fiber cable according to the present invention includes the fastening device formed at the inner peripheral portion thereof with the concave-convex section, thereby preventing excessive tension from being applied to the optical fiber. Accordingly, loss of the optical cable caused by breakage of the optical cable can be prevented and the manufacturing cost of the optical cable can be reduced.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. An apparatus for fabricating a metal coated optical fiber cable, the apparatus comprising:
a tape forming unit causing both side edges of a metal strip, subjected to traction, to abut against each other to form a metal tape;
an optical fiber guide unit for guiding an optical fiber or an optical fiber bundle into the metal tape;
a welding unit for welding the abutting edges of the metal strips; and
a fastening unit surrounding the metal tape for maintaining a shape of the metal tape, wherein an inner peripheral portion of the fastening unit includes at least one concave-convex section which makes contact with the metal tape.

2. The apparatus as claimed in claim 1, wherein the at least one concave-convex section of the fastening unit is continuously formed along the inner peripheral portion of the fastening unit in a semicircular cross-sectional shape.

3. The apparatus as claimed in claim 1, wherein the at least one concave-convex section of the fastening unit is continuously formed along the inner peripheral portion of the fastening unit is selected from the group consisting of: circular, angular, trapezoidal and triangular cross-sectional shape.

4. The apparatus as claimed in claim 1, wherein the at least one concave-convex section of the fastening unit extends lengthwise along the fastening unit in a helical pattern.

5. The apparatus as claimed in claim 1, wherein each of the at least one concave-convex section of the fastening unit has a height in a range of about 0.1 to 5 mm.

6. The apparatus as claimed in claim 1, wherein a number of concave parts or convex parts of the concave-convex section aligned in a circumferential direction of the fastening unit is in a range of about 5 to 20 per centimeter.

7. The apparatus as claimed in claim 1, wherein the fastening unit has an inner diameter in a range of about 1 to 100 mm.

8. The apparatus as claimed in claim 1, wherein the fastening unit includes a rolling die made from a metal.

9. The apparatus as claimed in claim 1, wherein the fastening unit includes a rolling die made from plastic.

10. The apparatus as claimed in claim 1, wherein the fastening unit includes a rolling die made from graphite.

11. A method for fabricating a metal coated optical fiber, the method comprising the steps of:
drawing concurrently an optical fiber and a metal strip sequentially through a tape forming unit, a welding unit and a fastening unit, wherein an inner peripheral portion of the fastening unit includes at least one concave-convex section which makes contact with the metal tape.
